(19) United States
(12) Patent Application Publication
(10) Pub. No.: US 2012/0088005 A1
(43) Pub. Date: Apr. 12, 2012

(54) SELF-ADJUSTING ANGLED EJECTOR

(75) Inventors: JIAN-MING LI, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/899,539

(22) Filed: Oct. 6, 2010

(51) Int. Cl. B29C 45/40

(52) U.S. Cl. 425/444

(57) ABSTRACT

Provided is a self-adjusting angled ejector including an angled ejector base, a fixing member, an angled ejector pin and two adjusting plates. The angled ejector pin disposes an undercut-forming portion projecting on an upper end thereof. A lower end of the angled ejector pin is received in a groove of the angled ejector base and is detachably fixed on it. The two adjusting plates form a rotating region therebetween for pivotally positioning the angled ejector base. When ejecting the product, the angled ejector base can rotate to adjust the angle of the angled ejector pin for preventing the angled ejector pin from being bent or broken. Moreover, the mould need not be disassembled when mounting or dismounting the angled ejector pin, thereby saving the assembling or disassembling time of the mould, improving the production efficiency of the mould, and reducing the man power and material resources.

### BACKGROUND OF THE INVENTION

1. Field of the Invention

The present invention relates to an ejection mechanism for an injection mould, and more particularly to a self-adjusting angled ejector.

2. Description of the Prior Art

An angled ejector is an ejection mechanism of an injection mould and is especially applied to form a groove or an undercut on an internal surface of a product. At present, when the angled ejector applied to the mould is used for mould ejection, a top end of the angled ejector is acting as a cavity core of the mould and is capable of sliding out from the groove or the undercut of the internal surface of the product, thereby completing the action of ejecting mould. When the prior angled ejector is mounted on the mould, an angled ejector pin of the ejector passes through an angled ejector hole of the mould, which can guide the ejector pin to slide along it. A lower end of the angled ejector is fixed on an ejector plate, which is mounted on a bottom plate and can slide along the bottom plate. A post rod passes through the bottom plate and is fixed on the ejector plate. The post rod can push the ejector plate to move for further driving the angled ejector pin to move along the angled ejector hole. During the movement of the angled ejector pin along the angled ejector hole, the ejector plate is sliding along the bottom plate. When the angled ejector is pushed out, the top end thereof acting as the cavity core is capable of sliding out from the groove or the undercut of the internal surface of the product, thereby realizing mould ejection.

However, because the angled ejector is fixed in the inner of mould, the mould must be disassembled when needing to mount or dismount the angled ejector. Therefore, the prior structure needs masses of man power and material resources and largely reduces the efficiency. Moreover, the errors generated in the machining process and the mounting process of the angled ejector may induce the angled ejector to generate torsion effect, or even to be bent or broken during the angled ejector being pushed out, so that reducing the reliability of the mould, shortening the useful life of the mould, and reducing the quality of the product.

### BRIEF SUMMARY OF THE INVENTION

An object of the present invention is to provide a self-adjusting angled ejector, being convenient for mounting or dismounting, being capable of self adjusting the errors generated in the machining or mounting process, and enhancing the using reliability.

To achieve the above object, in accordance with the present invention, a self-adjusting angled ejector is provided. The self-adjusting angled ejector comprises an angled ejector base, a fixing member, an angled ejector pin and two adjusting plates. The angled ejector base disposes a groove on a top surface thereof. The angled ejector pin disposes an undercut-forming portion projecting on an upper end thereof, wherein a lower end of the angled ejector pin is received in the groove and is detachably fixed on the angled ejector base by the fixing member. The two adjusting plates are parallel to each other and form a rotating region therebetween, wherein the angled ejector base is pivotally located on the rotating region.

Based on the above description, the angled ejector pin of the present invention is received in the groove of the angled ejector base and is detachably fixed on the angled ejector base by the fixing member, so that the angled ejector pin can be conveniently detached from the mould by removing the fixing member. Namely, the mould need not be disassembled when mounting or dismounting the angled ejector pin, thereby saving the assembling or disassembling time of the mould, improving the production efficiency of the mould, and reducing the man power and material resources. Moreover, because the angled ejector base is pivotally mounted within the rotating region between the two parallel adjusting plates, and the two adjusting plates are held in the mounting groove, the angled ejector base can correspondingly perform a rotating action to adjust the angle of the angled ejector pin when the angled ejector pin is caused to be turned due to the self errors or mounting errors. The angled ejector pin can be prevented from being bent or broken during ejecting the product, thereby enhancing the safety and the reliability of the self-adjusting angled ejector and the mould, elongating the useful life of the mould, and improving the quality of the product.

### BRIEF DESCRIPTION OF THE DRAWINGS

FIG. 1 is a perspective view of a self-adjusting angled ejector according to one embodiment of the present invention;

FIG. 2 is an exploded view of the self-adjusting angled ejector of FIG. 1;

FIG. 3 is a sectional view of the self-adjusting angled ejector of FIG. 1;

FIG. 4 is a schematic view showing that the self-adjusting angled ejector is mounted on a mould; and

FIG. 5 is a schematic view showing that the self-adjusting angled ejector ejects the product from the mould.

### DETAILED DESCRIPTION OF THE PREFERRED EMBODIMENTS

The following embodiment with reference to the accompanying drawings now has been given for detail describing the technology, the feature, the object and the effect of the present invention.

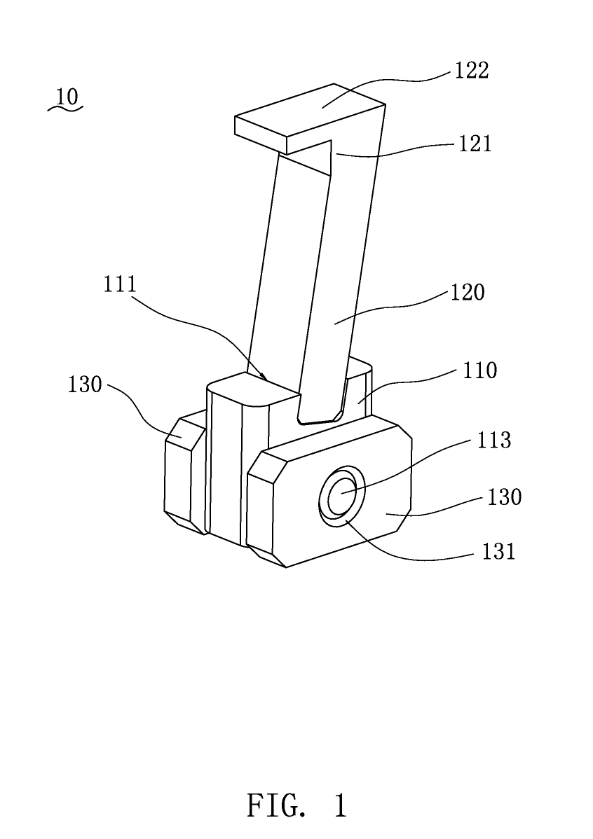

Please refer to FIG. 1, a self-adjusting angled ejector 10 of the present invention comprises an angled ejector base 110, an angled ejector pin 120, a fixing member and two adjusting plates 130. The angled ejector base 110 disposes a groove 111 on a top surface thereof. The angled ejector pin 120 disposes a connecting portion 121, which directly extends from an upper end thereof and forms an obtuse angle with the upper end thereof, and an undercut-forming portion 122, which extends from the connecting portion 121 and forms a right angle with the connecting portion 121. The undercut-forming portion 122 has a plate-shaped structure. A lower end of the angled ejector pin 120 is received in the groove 111 and is detachably fixed on the angled ejector base 110 by the fixing member. The two adjusting plates 130 are parallel to each other and form a rotating region therebetween. Each one of the two adjusting plates 130 disposes a pivot hole 131 straightly facing the rotating region. The angled ejector base 110 disposes two connecting posts 113, which are separately protruding from two side surfaces thereof and are separately engaged with the pivot holes 131. The angled ejector base 110 is pivotally mounted on the rotating region.

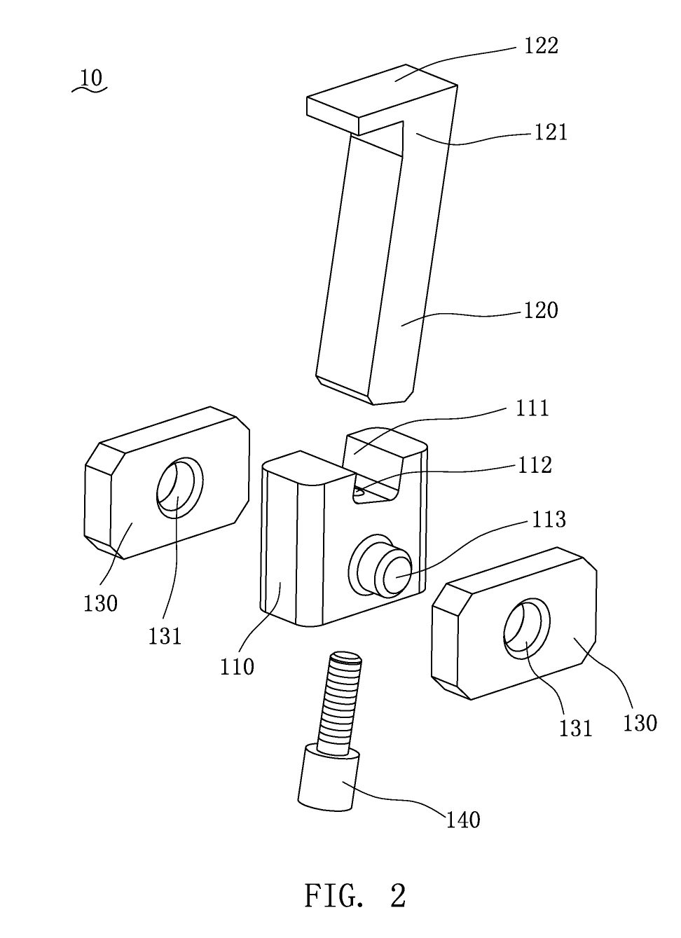

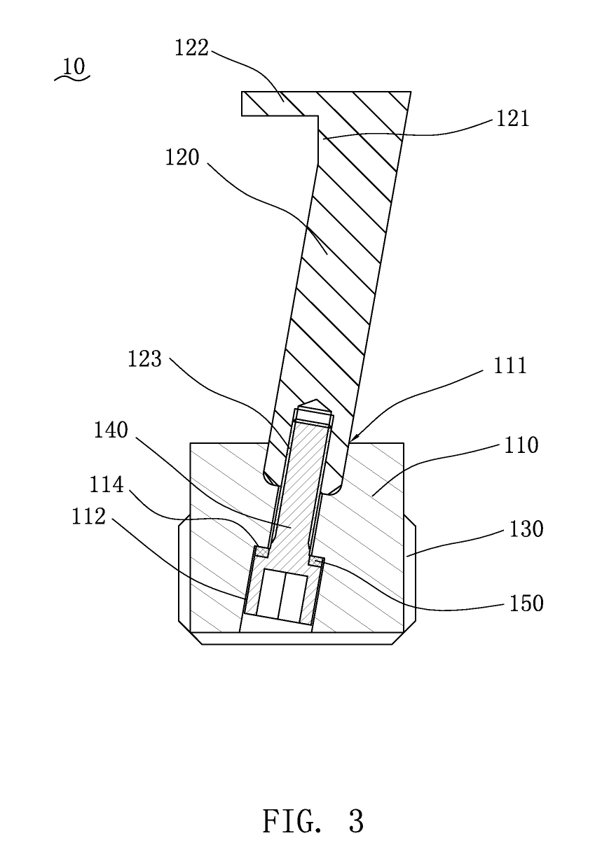

Referring to FIGS. 2 and 3, in one embodiment of the present invention, the fixing member is a bolt 140. The angled ejector base 110 disposes a through hole 112 passing through a bottom surface thereof and the groove 111. The through hole 112 has a step-like structure and forms at least one shoulder 114 adjacent to the bottom surface of the angled ejector base 110. A bottom of the angled ejector pin 120 disposes a mounting hole 123, which is corresponding to the through hole 112 and has an internal screw thread. When the lower end of the angled ejector pin 120 is received in the groove 111, the bolt 140 enters into the through hole 112 from the bottom surface of the angled ejector base 110 and passes through the through hole 112, and then rotateably enters into the mounting hole 123 for being coupled to the internal screw thread. Now, the bolt 140 contacts with the shoulder 114 of the through hole 112. Further, a spring washer 150 is located between the bolt 140 and the shoulder 114 of the through hole 112. By the above structures, the angled ejector pin 120 is mounted on the angled ejector base 110. The two connecting posts 113 of the angled ejector base 110 are cylindrical, the angled ejector base 110 is located within the rotating region and the two connecting posts 113 are pivotally engaged with the pivot hole 131, so that the angled ejector base 110 is pivotally mounted within the rotating region and a lower end of the two adjusting plate 130 is protruding from the bottom surface of the angled ejector base 110.

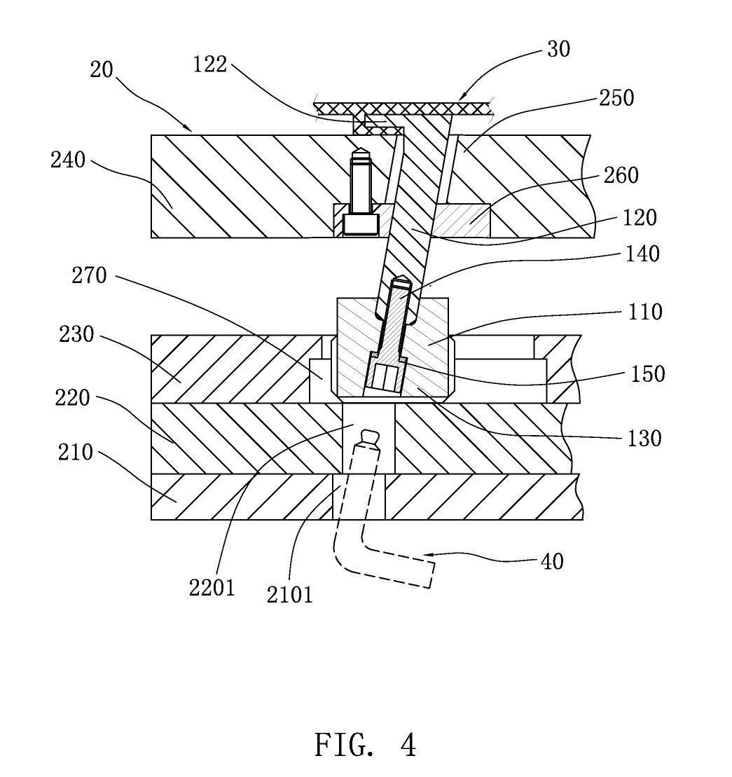

Referring to FIG. 4, the self-adjusting angled ejector 10 of the present invention is mounted on a mould 20 for producing a product 30 with undercut. An ejector plate 230 of the mound 20 disposes a mounting groove 270 corresponding to the two adjusting plates 130. The two adjusting plates 130 are held in the mounting groove 270 and are capable of sliding in the mounting groove 270. An upper ejector plate 240 disposes an angled ejector hole 250. A limiting plate 260 is mounted in the lower portion of the angled ejector hole 250 for guiding the angled ejector pin 120 to move upward. Both a lower ejector plate 220 and a bottom plate 210 dispose process holes 2201, 2101, which are corresponding to the angled ejector base 110 and are used for dismounting or mounting the angled ejector pin 120. When the angled ejector pin 120 needs to be removed from the mould 20, a tool 40 enters into the through hole 112 of the angled ejector base 110 from the process holes 2201, 2101 for unscrewing the bolt 140, thereby making the angled ejector pin 120 be removed. The mounting process is also as above. Therefore, the angled ejector base 110 can be conveniently mounted to or dismounted from the mould 20, which need not be disassembled.

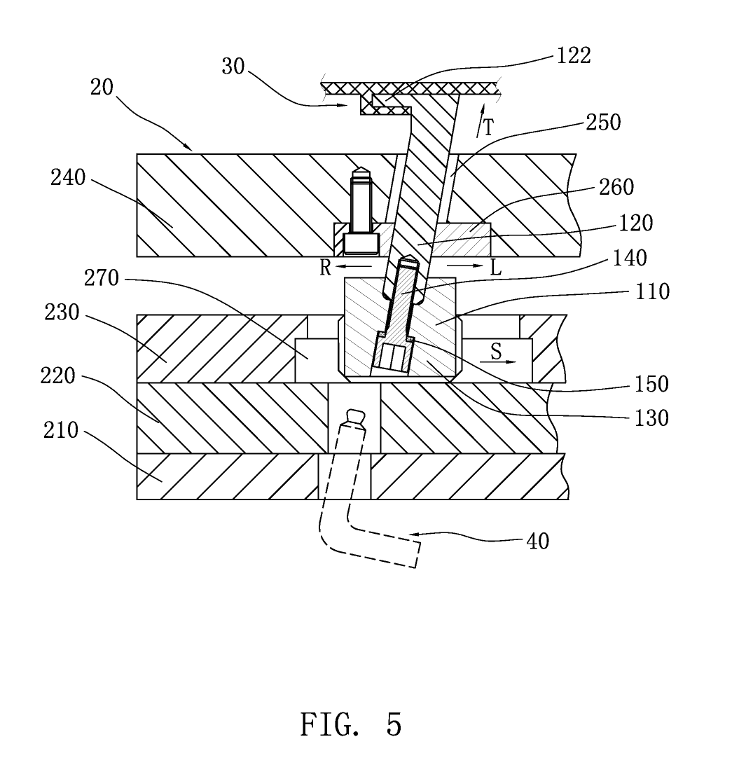

Referring to FIG. 5, when the finished product 30 need be ejected from the mould 20 by means of the self-adjusting angled ejector 10, first the bottom plate 210 is driven to push the angled ejector pin 120 moving along a direction T limited by the limiting plate 260, simultaneously the angled ejector base 110 and the adjusting plates 130 are horizontally sliding along a direction S of FIG. 5. During the movement of the angled ejector pin 120, errors, which are existed in the engagement between the angled ejector pin 120 and the limiting plate or generated in the machining process of the angled ejector pin 120, may induce the angled ejector pin 120 to be turned along a direction R or L. In one embodiment, the angled ejector pin 120 can be turned along the direction L, and because the adjusting plates are held within the mounting groove 270, the angled ejector base 110 can rotate a certain angle around the connecting posts 113 for compensating the errors and making the angled ejector pin 120 stably slide along the direction T. Whereby the angled ejector pin 120, which may be turned because of the machining and mounting errors, can be prevented from being bent or broken in the course of sliding along the direction T. Therefore, the safety and the reliability of the self-adjusting angled ejector 10 and the mould 20 can be enhanced.

As described above, the self-adjusting angled ejector 10 of the present invention is mounted on the angled ejector base 110 by the bolt 140 passing through the bottom surface and the groove 111 of the angled ejector base 110. Therefore, the bolt 140 can be released from the angled ejector base 110 by the process holes 2201, 2101 of the mould 20, and then the angled ejector pin 120 can be conveniently dismounted. It is obvious that the mould 20 need not be disassembled when mounting or dismounting the angled ejector pin 120. Therefore, the assembling or disassembling time of the mould 20 can be saved, the production efficiency of the mould 20 can be improved, and the man power and material resources can be reduced. Moreover, because the angled ejector base 110 is pivotally mounted within the rotating region between the two adjusting plates 130, and the two adjusting plates 130 are held in the mounting groove 270, the angled ejector base 110 can correspondingly perform a rotating action to adjust the angle of the angled ejector pin 120 when the angled ejector pin 120 is caused to be turned due to the machining or mounting errors of self. Therefore, the angled ejector pin 120 can be prevented from being bent or broken during ejecting the product, the safety and the reliability of the self-adjusting angled ejector 10 and the mould 20 can be enhanced, the useful life of the mould 20 can be elongated, and the quality of the product can be assured.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A self-adjusting angled ejector, comprising:
an angled ejector base, disposing a groove on a top surface thereof;
a fixing member;
an angled ejector pin, disposing an undercut-forming portion projecting on an upper end thereof, wherein a lower end of the angled ejector pin is received in the groove and is detachably fixed on the angled ejector base by the fixing member; and
two adjusting plates, being parallel to each other and forming a rotating region therebetween, wherein the angled ejector base is pivotally located on the rotating region.

2. The self-adjusting angled ejector as claimed in claim 1, wherein each one of the two adjusting plates disposes a pivot hole straightly facing the rotating region, and the angled ejector base disposes two connecting posts, which are separately protruding from two side surfaces thereof and are pivotally engaged with the pivot holes.

3. The self-adjusting angled ejector as claimed in claim 2, wherein the two connecting posts are cylindrical.

4. The self-adjusting angled ejector as claimed in claim 1, wherein the angled ejector pin further disposes a mounting hole with an internal screw thread on the lower end thereof, the angled ejector base disposes a through hole corresponding to the mounting hole and passing through a bottom surface thereof and the groove, and the fixing member passes through the through hole to be coupled to the mounting hole.

5. The self-adjusting angled ejector as claimed in claim 4, wherein the fixing member is a bolt.

6. The self-adjusting angled ejector as claimed in claim 1, wherein the undercut-forming portion of the angled ejector pin has a plate-shaped structure.

7. The self-adjusting angled ejector as claimed in claim 1, wherein the angled ejector pin further disposes a connecting portion directly extending from the upper end thereof and forming an obtuse angle with the upper end thereof, and the undercut-forming portion is extending from the connecting portion and forming a right angle with the connecting portion.
